(19) United States
(12) Patent Application Publication
(10) Pub. No.: US 2026/0238928 A1
(43) Pub. Date: Aug. 13, 2026

(54) Sound Generator

(71) Applicant: AAC Microtech (Changzhou) Co., Ltd., Changzhou City (CN)

(72) Inventors: Zhujiang Xu, Changzhou (CN); Wu Wang, Changzhou (CN)

(21) Appl. No.: 19/333,420

(22) Filed: Sep. 19, 2025

Related U.S. Application Data
(63) Continuation of application No. PCT/CN2025/079692, filed on Feb. 28, 2025.

(30) Foreign Application Priority Data
Feb. 10, 2025 (CN) 202520210686.0

(51) Int. Cl. H04R 9/06; H04R 7/04; H04R 7/18; H04R 9/02; H04R 9/04

(52) U.S. Cl. CPC H04R 9/063; H04R 7/04; H04R 7/18; H04R 9/025; H04R 9/046; H04R 2400/11

(57) ABSTRACT

The present application provides a sound generator including a frame having a first frame and a second frame, a first vibration system, a second vibration system, a first plate, and a second plate. The second plate includes an annular second plate body, a first connecting portion, a second connecting portion, and a supporting portion parallel to the second plate body and located on a side of the second plate body close to the first diaphragm; and a magnetic circuit system. The magnetic circuit system includes a first main magnet unit and a second main magnet unit, first side magnets, and second side magnets. Compared with related technology, the sound generator of the present application has lower coil manufacturing process difficulty and higher plate safety.

### TECHNICAL FIELD

The present application relates to the field of electroacoustic transducer technology, and particularly relates to a sound generator.

### BACKGROUND

A sound generator is a transducer device that converts electrical signals into sound signals, mainly divided into single vibration system and dual vibration system modes. Among them, a sound generator with dual vibration system mode mainly includes a frame, a plate fixed to the frame, a first vibration system fixed to the frame for generating sound, a second vibration system, and a magnetic circuit system for driving the first vibration system and the second vibration system to vibrate, wherein the magnetic circuit system is fixed to the plate.

In the sound generator of related technology, the first vibration system and the second vibration system are respectively located on opposite sides of the magnetic circuit system. The first vibration system includes a first diaphragm fixed to the frame and a first coil driving the diaphragm to vibrate. The second vibration system includes a second diaphragm fixed to the frame and a second coil driving the diaphragm to vibrate. The first coil and the second coil are suspended in magnetic gaps of the magnetic circuit system, and dual vibration sound generation is achieved by driving two coils through the magnetic circuit system. However, when the length-to-width ratio of the sound generator product is relatively large, the inner second coil has high manufacturing process difficulty, making it difficult to form or causing large dimensional fluctuations during formation. Meanwhile, the plate only has connection points in one direction, which leads to high risk of deformation after mechanical testing when the dimension in the direction without connection points is large.

Therefore, it is necessary to provide a new sound generator to solve the above problems.

### SUMMARY

The technical problem to be solved by the present application is to provide a sound generator with lower coil manufacturing process difficulty and higher plate structural strength.

To solve the above technical problem, an embodiment of the present application provides a sound generator. The sound generator includes:

a frame having a first frame and a second frame fixed to the first frame;

a first vibration system, fixed to a side of the first frame away from the second frame; wherein the first vibration system comprises a first diaphragm fixed to the first frame and a first coil driving the first diaphragm to vibrate and generate sound;

a second vibration system, wherein the second vibration system is fixed to a side of the second frame away from the first frame; the second vibration system comprises a second diaphragm fixed to the second frame, and a second coil and a third coil jointly driving the second diaphragm to vibrate and generate sound;

an annular first plate, wherein an outer periphery of the first plate is fixed to the first frame;

a second plate, wherein the second plate comprises an annular second plate body fixed to the second frame, a first connecting portion formed by bending and extending from opposite two sides of the second plate body in a direction away from the second diaphragm, a second connecting portion formed by bending and extending from another opposite two sides of the second plate body in the direction away from the second diaphragm, and a supporting portion parallel to the second plate body and located on a side of the second plate body close to the first diaphragm; ends of the first connecting portion and the second connecting portion away from the second plate body are respectively fixed to the supporting portion; and

a magnetic circuit system, wherein the magnetic circuit system comprises a first main magnet unit and a second main magnet unit arranged side by side and fixed to a side of the supporting portion away from the first diaphragm, first side magnets fixed to the second plate body and arranged on opposite sides of the first main magnet unit along a direction parallel to a longitudinal axis of the magnetic circuit system, and second side magnets fixed to the second plate body and arranged on opposite sides of the second main magnet unit along the direction parallel to the longitudinal axis of the magnetic circuit system; the first side magnets and the second side magnets are respectively spaced apart from the first main magnet unit and the second main magnet unit to form magnetic gaps, the second coil and the third coil are respectively spaced apart within the first coil, and the first coil, the second coil and the third coil are respectively inserted into the magnetic gaps; the first side magnets and the second side magnets are respectively fixed to the first plate.

Preferably, the second plate body, the first connecting portion, the second connecting portion and the supporting portion are integrally formed.

Preferably, the first connecting portion, the second connecting portion and the supporting portion are integrally formed, and are fixedly connected to the second plate body through the first connecting portion and the second connecting portion.

Preferably, a first recess and a second recess are respectively formed by recessing on a side of the second plate body close to the second diaphragm, the first recess is located at the opposite two sides of the second plate body, and the second recess is located at the another opposite two sides of the second plate body;

the first connecting portion comprises a first connecting portion body fixed to the supporting portion and a first step formed by recessing from the first connecting portion body in a direction away from the first diaphragm; the first step is disposed in the first recess;

the second connecting portion comprises a second connecting portion body fixed to the supporting portion and a second step formed by recessing from the second connecting portion body in the direction away from the first diaphragm; the second step is disposed in the second recess.

Preferably, the first diaphragm comprises an annular first suspension, a first fixing portion extending outward from an outer periphery of the first suspension, a first vibration unit extending inward from an inner periphery of the first suspension, and a first dome fixed to a side of the first vibration unit close to the second vibration system; the first fixing portion is fixed to the side of the first frame away from the second vibration system, and the first coil is fixed to a side of the first dome close to the second vibration system.

Preferably, the sound generator further comprises a first circuit board, one end of the first circuit board is fixed to a side of the first frame close to the second frame, and another end of the first circuit board is fixed to a side of the first coil away from the second vibration system to achieve electrical connection.

Preferably, the second diaphragm comprises an annular second suspension, a second fixing portion extending outward from an outer periphery of the second suspension, a second vibration unit extending inward from an inner periphery of the second suspension, and a second dome fixed to a side of the second vibration unit away from the first vibration system; the second fixing portion is fixed to the side of the second frame away from the first vibration system, and the second coil and the third coil are respectively fixed to a side of the second fixing portion away from the second dome.

Preferably, the sound generator further comprises a second circuit board, the second circuit board is stacked and fixed to the side of the second frame away from the first vibration system; the second diaphragm is stacked and fixed to a side of the second circuit board away from the first frame, the second coil and the third coil are respectively fixed to a side of the second circuit board close to the first vibration system, and the second circuit board is respectively electrically connected to the second coil and the third coil.

Preferably, the first main magnet unit comprises a first main magnet fixed to the supporting portion and a first pole plate stacked and fixed to a side of the first main magnet away from the first vibration system; the second main magnet unit comprises a second main magnet fixed to the supporting portion and a second pole plate stacked and fixed to a side of the second main magnet away from the second vibration system; the first main magnet and the second main magnet respectively form the magnetic gaps with the first side magnets and the second side magnets.

Compared with related technology, in the sound generator of the present application, by mounting the first vibration system and the second vibration system respectively on the first frame and the second frame, wherein the second vibration system includes a second diaphragm fixed to the second frame, and a second coil and a third coil jointly driving the second diaphragm to vibrate and generate sound; fixing the outer periphery of the first plate to the first frame. The second plate includes an annular second plate body fixed to the second frame, a first connecting portion formed by bending and extending from opposite two sides of the second plate body in a direction away from the second diaphragm, a second connecting portion formed by bending and extending from another opposite two sides of the second plate body in the direction away from the second diaphragm, and a supporting portion parallel to the second plate body and located on a side of the second plate body close to the first diaphragm.

Ends of the first connecting portion and the second connecting portion away from the second plate body are respectively fixed to the supporting portion; the magnetic circuit system includes a first main magnet unit and a second main magnet unit arranged side by side and fixed to a side of the supporting portion away from the first diaphragm, first side magnets fixed to the second plate body and arranged on opposite sides of the first main magnet unit along a direction parallel to the longitudinal axis of the magnetic circuit system, and second side magnets fixed to the second plate body and arranged on opposite sides of the second main magnet unit along the direction parallel to the longitudinal axis of the magnetic circuit system; by having opposite first connecting portions and opposite second connecting portions in both length and width directions of the second plate. The manufacturing process difficulty of smaller coils in products with larger length-to-width ratios is reduced, greatly reducing the risk of deformation of the irregular upper plate after mechanical testing, improving plate safety, and broadening the application range.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of a sound generator according to Embodiment 1 of the present application;

FIG. 2 is an exploded view of the sound generator;

FIG. 3 is a cross-sectional view of the sound generator taken along line A-A in FIG. 1;

FIG. 4 is a cross-sectional view of the sound generator taken along line B-B in FIG. 1;

FIG. 5 is an isometric illustration of a second plate of the sound generator;

FIG. 6 is an isometric illustration of a second plate of a sound generator according to Embodiment 2 of the present application;

FIG. 7 is an exploded view of the second plate in FIG. 6;

FIG. 8 is an isometric illustration of a second plate of a sound generator according to Embodiment 3 of the present application;

FIG. 9 is an exploded view of the second plate in FIG. 8.

### DETAILED DESCRIPTION OF THE EMBODIMENTS

To further explain the embodiments, the present application provides drawings. These drawings form part of the disclosure of the present application and are mainly used to explain the embodiments and can be used to explain the operating principles of the embodiments in conjunction with the related descriptions in the specification. With reference to these contents, those skilled in the art should be able to understand other possible implementations and advantages of the present application. The components in the drawings are not drawn to scale, and similar component symbols are generally used to indicate similar components.

### Embodiment 1

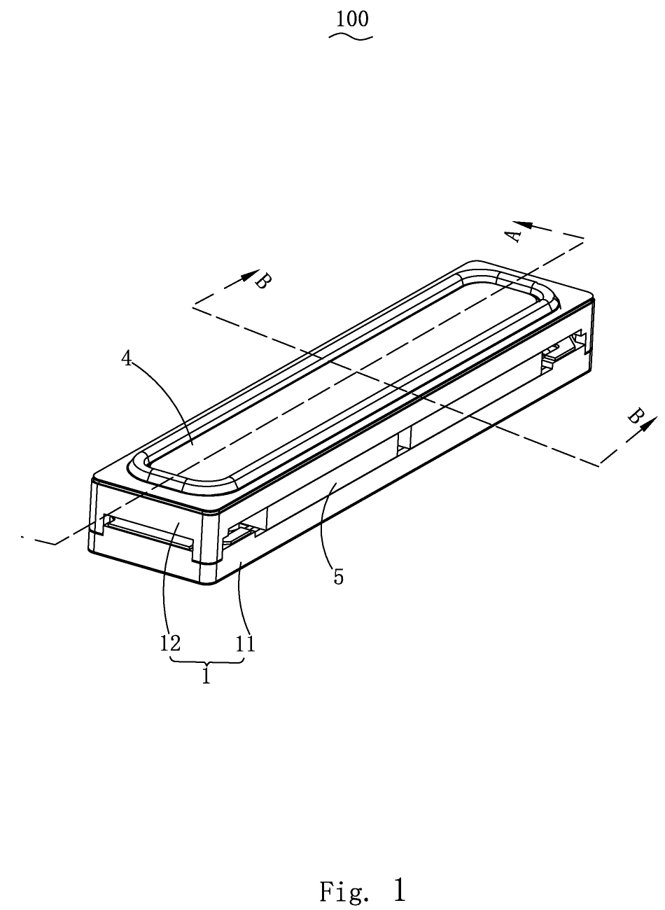

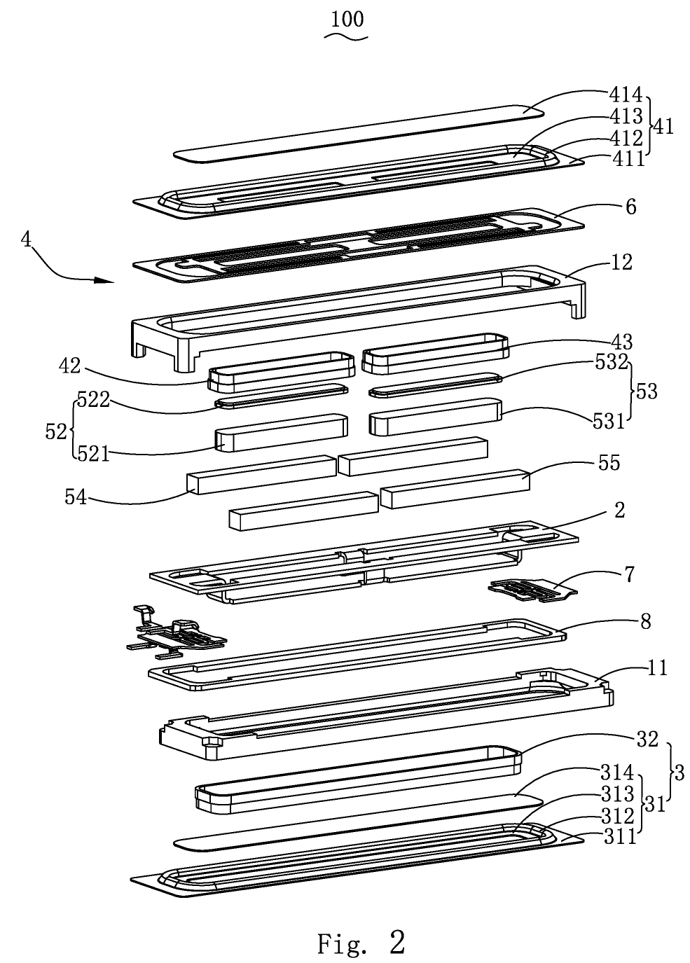

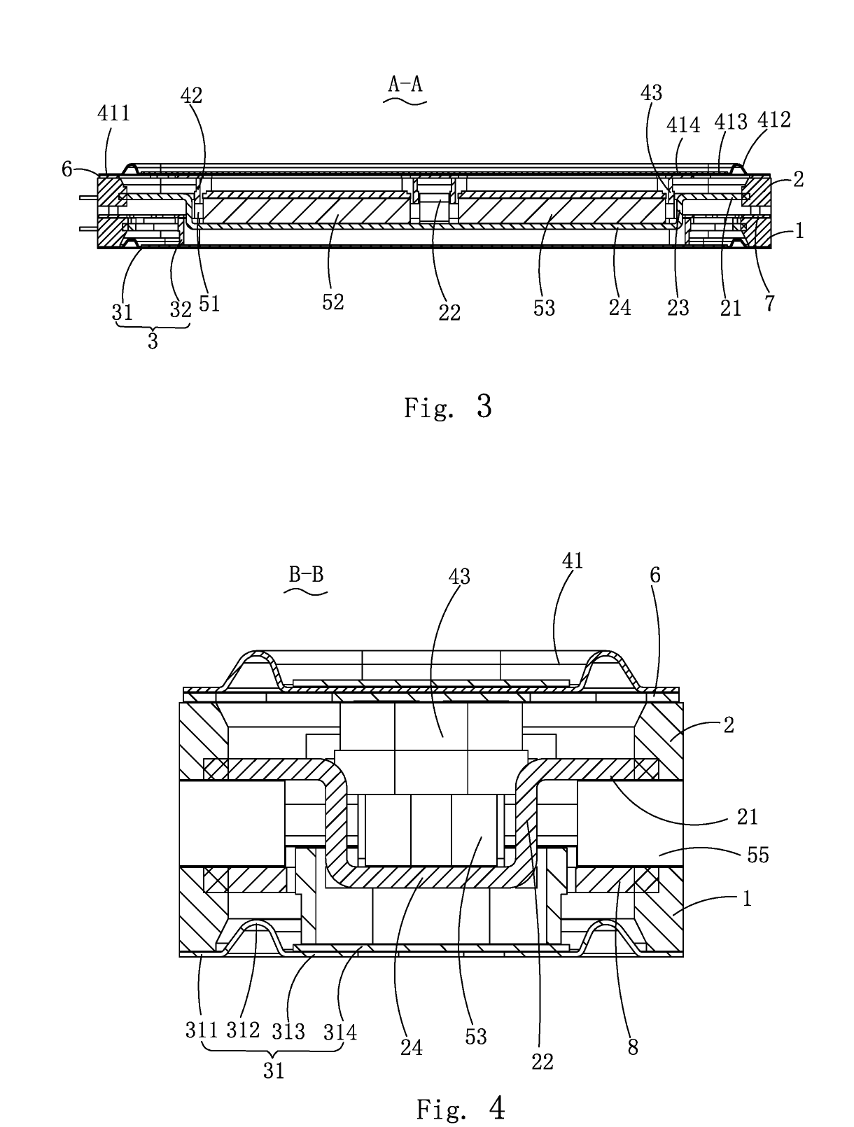

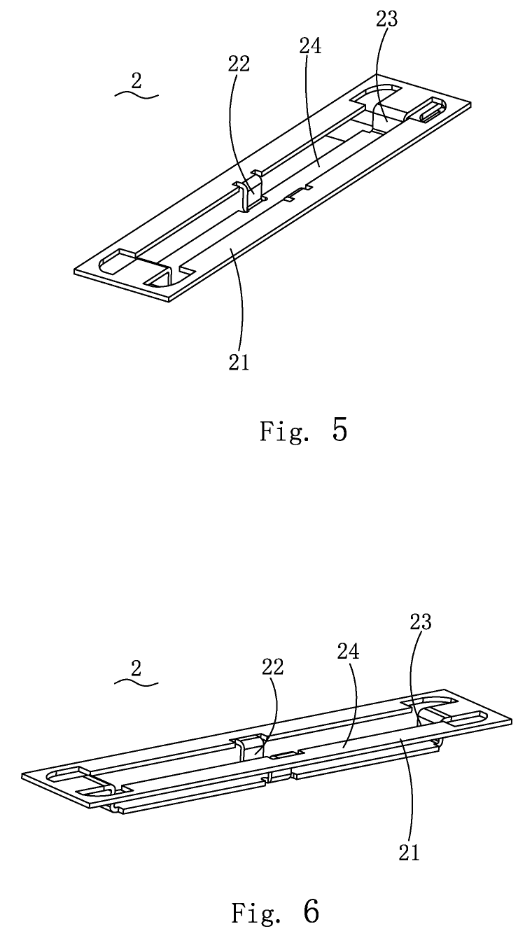

Please refer to FIGS. 1-5, this embodiment of the present application provides a sound generator 100, which comprises: a frame 1, a first vibration system 3, a second vibration system 4, and a magnetic circuit system 5.

The frame 1 comprises a first frame 11 and a second frame 12 fixed to the first frame 11. Optionally, the first frame 11 and the second frame 12 are integrally formed. Of course, the first frame 11 and the second frame 12 can be separately structured to facilitate the assembly of the first frame 11 and the second frame 12 in the sound generator.

The first frame 11 is used for mounting and fixing the first vibration system 3. The second frame 12 is stacked and fixed to the first frame 11.

The first vibration system 3 is fixed to a side of the first frame 11 away from the second frame 12; the first vibration system 3 comprises a first diaphragm 31 fixed to the first frame 11 and a first coil 32 driving the first diaphragm 31 to vibrate and generate sound.

The second vibration system 4 is fixed to a side of the second frame 12 away from the first frame 11; the second vibration system 4 comprises a second diaphragm 41 fixed to the second frame 12, and a second coil 42 and a third coil 43 jointly driving the second diaphragm 41 to vibrate and generate sound. The second vibration system 4 achieves dual-drive sound generation through the second coil 42 and the third coil 43, providing good vibration performance.

In this embodiment, the sound generator 100 further comprises an annular first plate 8, wherein an outer periphery of the first plate 8 is fixed to the first frame 11.

The second plate 2 comprises an annular second plate body 21 fixed to the second frame 12, a first connecting portion 22 formed by bending and extending from opposite two sides of the second plate body 21 in a direction away from the second diaphragm 41, a second connecting portion 23 formed by bending and extending from another opposite two sides of the second plate body 21 in the direction away from the second diaphragm 41, and a supporting portion 24 parallel to the second plate body 21 and located on a side of the second plate body 21 close to the first diaphragm 31; ends of the first connecting portion 22 and the second connecting portion 23 away from the second plate body 21 are respectively fixed to the supporting portion 24. By having opposite first connecting portions 22 and opposite second connecting portions 23 in both length and width directions of the second plate 2, the manufacturing process difficulty of smaller coils in products with larger length-to-width ratios is reduced, greatly reducing the risk of deformation of the irregular second plate 2 after mechanical testing, improving the safety of the second plate 2, and broadening the application range. The second plate 2 is fixed to the second frame 12 by injection molding, and the material of the second plate 2 is SPCC material, which has high structural strength.

Optionally, the second plate 2 is fixed to the inner peripheral side of the second frame 12. The first connecting portion 22 includes two portions, which are arranged on opposite sides of the long axis of the second plate body 21. The second connecting portion 23 includes two portions, which are arranged on opposite sides of the short axis of the second plate body 21.

The magnetic circuit system 5 is fixed to the second plate 2; the magnetic circuit system 5 comprises a first main magnet unit 52 and a second main magnet unit 53 arranged side by side and fixed to a side of the supporting portion 24 away from the first diaphragm 31, first side magnets 54 fixed to the second plate body 21 and arranged on opposite sides of the first main magnet unit 52 along a direction parallel to the longitudinal axis of the magnetic circuit system 5, and second side magnets 55 fixed to the second plate body 21 and arranged on opposite sides of the second main magnet unit 53 along the direction parallel to the longitudinal axis of the magnetic circuit system 5; the first side magnets 54 and the second side magnets 55 are respectively spaced apart from the first main magnet unit 52 and the second main magnet unit 53 to form magnetic gaps 51, the second coil 42 and the third coil 43 are respectively spaced apart within the first coil 31, and the first coil 32, the second coil 42 and the third coil 43 are respectively inserted into the magnetic gaps 51. The first side magnets 54 and the second side magnets 55 are respectively fixed to the first plate 8. The second coil 42 and the third coil 43 are respectively spaced apart on the inner side of the first coil 32. The first main magnet unit 52 and the second main magnet unit 53 are spaced apart and fixed to the side of the supporting portion 24 away from the first diaphragm 31; the first side magnets 54 and the second side magnets 55 are respectively fixed to the side of the second plate body 21 away from the first diaphragm 31. Through the magnetic fields generated between the first main magnet unit 52 and the second main magnet unit 53 respectively with the first side magnets 54 and the second side magnets 55, the first coil 32, the second coil 42 and the third coil 43 are driven to vibrate and generate sound.

Optionally, when the side of the first frame 11 and the first plate 8 close to the second diaphragm 41 are in the same plane, the first side magnets 54 are respectively fixed to the first frame 11 and the first plate 8; the second side magnets 55 are respectively fixed to the first frame 11 and the first plate 8. This improves the fixing effect of the first side magnets 54 and the second side magnets 55.

In this embodiment, the second plate body 21, the first connecting portion 22, the second connecting portion 23, and the supporting portion 24 are integrally formed. The integral structure is convenient to form and has high structural strength, reducing the risk of deformation of the second plate 2 after mechanical testing. Meanwhile, the integrally formed structure is formed by stamping and injection molding, making the first connecting portion 22 and the second connecting portion 23 perpendicular to the second plate body 21 respectively, and the supporting portion 24 parallel to the second plate body 21, resulting in good molding performance.

In this embodiment, the first diaphragm 31 comprises an annular first suspension 312, a first fixing portion 311 extending outward from an outer periphery of the first suspension 312, a first vibration unit 313 extending inward from an inner periphery of the first suspension 312, and a first dome 314 fixed to a side of the first vibration unit 313 close to the second vibration system 4; the first fixing portion 311 is fixed to the side of the first frame 11 away from the second vibration system 4, and the first coil 32 is fixed to a side of the first dome 314 close to the second vibration system 4.

In this embodiment, the second diaphragm 41 comprises an annular second suspension 412, a second fixing portion 411 extending outward from an outer periphery of the second suspension 412, a second vibration unit 413 extending inward from an inner periphery of the second suspension 412, and a second dome 414 fixed to a side of the second vibration unit 413 away from the first vibration system 3; the second fixing portion 411 is fixed to the side of the second frame 12 away from the first vibration system 3, and the second coil 42 and the third coil 43 are respectively fixed to a side of the second fixing portion 411 away from the second dome 414.

In this embodiment, the sound generator 100 further comprises a first circuit board 7, one end of the first circuit board 7 is fixed to a side of the first frame 11 close to the second frame 12, and another end of the first circuit board 7 is fixed to a side of the first coil 32 away from the second vibration system 4 to achieve electrical connection. The first circuit board 7 can be an FPC board for conducting electricity. There are two first circuit boards 7, respectively arranged at opposite ends of the first coil 32, which can increase the vibration strength of the first diaphragm 31 to improve sound loudness and sensitivity; prevent lateral swinging when the first coil 32 vibrates, improving reliability.

In this embodiment, the sound generator 100 further comprises a second circuit board 6, the second circuit board 6 is stacked and fixed to the side of the second frame 12 away from the first vibration system 3; the second diaphragm 41 is stacked and fixed to a side of the second circuit board 6 away from the first frame 11, the second coil 42 and the third coil 43 are respectively fixed to a side of the second circuit board 6 close to the first vibration system 3, and the second circuit board 6 is respectively electrically connected to the second coil 42 and the third coil 43. The end of the second circuit board 6 away from the second frame 12 is used to connect to an external power source, providing power to the second coil 42 and third coil 43 through the external power source connection, enabling the second coil 42 and third coil 43 to drive the second diaphragm 41 to vibrate and generate sound when electrified. The dual-coil arrangement ensures good vibration performance of the second diaphragm 41. Optionally, the second circuit board 6 is an FPC board.

In this embodiment, the first main magnet unit 52 comprises a first main magnet 521 fixed to the supporting portion 24 and a first pole plate 522 stacked and fixed to a side of the first main magnet 521 away from the first vibration system 3; the second main magnet unit 53 comprises a second main magnet 531 fixed to the supporting portion 24 and a second pole plate 532 stacked and fixed to a side of the second main magnet 531 away from the second vibration system 4; the first main magnet 521 and the second main magnet 531 respectively form the magnetic gaps 51 with the first side magnets 54 and the second side magnets 55.

### Embodiment 2

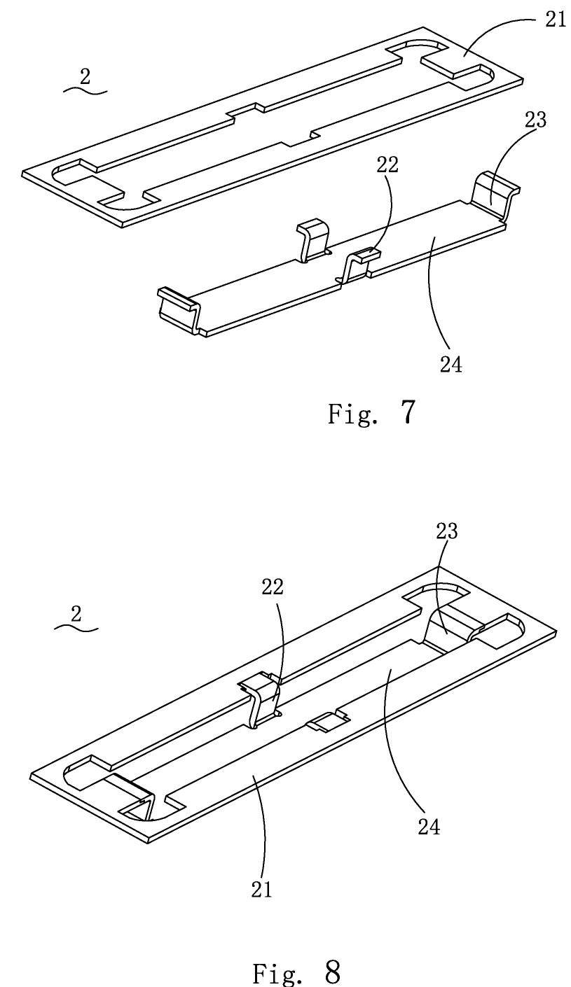

Please refer to FIGS. 1-7, Embodiment 2 has basically the same structure as Embodiment 1, with the difference being that in this embodiment, the first connecting portion 22, the second connecting portion 23 and the supporting portion 24 are integrally formed, and are fixedly connected to the second plate body 21 through the first connecting portion 22 and the second connecting portion 23. This achieves a separate structure setup, allowing the structural dimensions and shape of the supporting portion 24 to be adjusted arbitrarily, facilitating flexible arrangement and broad application range.

### Embodiment 3

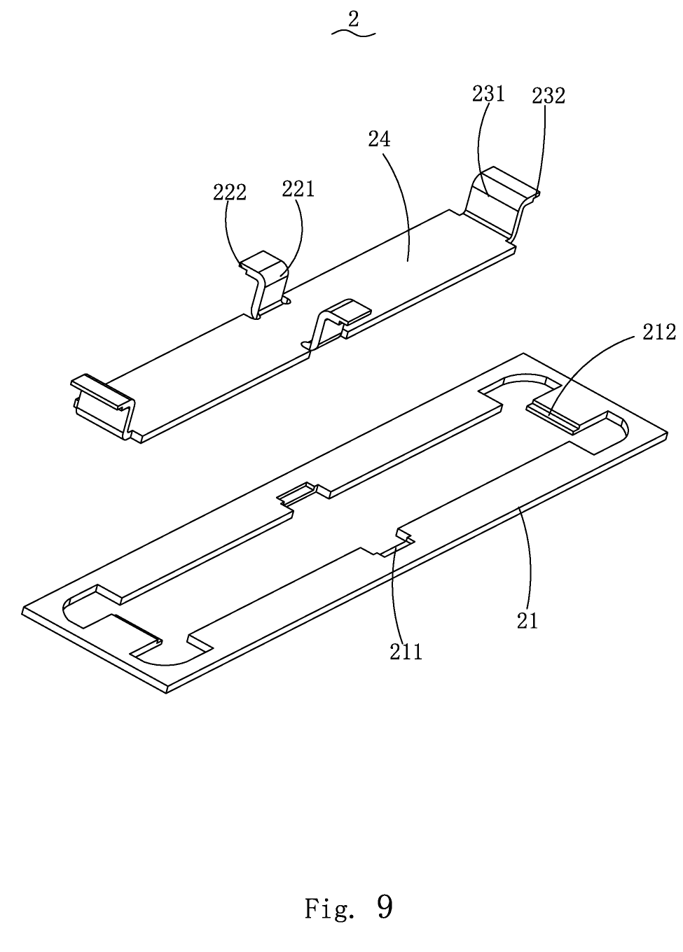

Please refer to FIGS. 8-9, Embodiment 3 has basically the same structure as Embodiment 2, with the difference being that in this embodiment, a first recess 211 and a second recess 212 are respectively formed by recessing on a side of the second plate body 21 close to the second diaphragm 41, the first recess 211 is located at the opposite two sides of the second plate body 21, and the second recess 212 is located at the other opposite two sides of the second plate body 21.

The first connecting portion 22 comprises a first connecting portion body 221 fixed to the supporting portion 24 and a first step 222 formed by recessing from the first connecting portion body 221 in a direction away from the first diaphragm 31; the first step 222 is disposed in the first recess 211. The second connecting portion 23 comprises a second connecting portion body 231 fixed to the supporting portion 24 and a second step 232 formed by recessing from the second connecting portion body 231 in the direction away from the first diaphragm 31; the second step 232 is disposed in the second recess 212. Through the cooperation between the first step 222 and the first recess 211, and between the second step 232 and the second recess 212, the first connecting portion 22 and the second connecting portion 23 can be conveniently installed and fixed to the second plate body 21, saving assembly space.

Optionally, there are two first recesses 211 and two second recesses 212, with the first recesses 211 located along the long axis direction of the second plate body 21, and the second recesses 212 located along the short axis direction of the second plate body 21. There are also two first steps 222 and two second steps 232, which are respectively fixed in cooperation with the first recesses 211 and the second recesses 212.

Compared with related technology, in the sound generator of the present application, by mounting the first vibration system and the second vibration system respectively on the first frame and the second frame, wherein the second vibration system includes a second diaphragm fixed to the second frame, and a second coil and a third coil jointly driving the second diaphragm to vibrate and generate sound; fixing the outer periphery of the first plate to the first frame; the second plate includes an annular second plate body fixed to the second frame, a first connecting portion formed by bending and extending from opposite two sides of the second plate body in a direction away from the second diaphragm, a second connecting portion formed by bending and extending from another opposite two sides of the second plate body in the direction away from the second diaphragm, and a supporting portion parallel to the second plate body and located on a side of the second plate body close to the first diaphragm; ends of the first connecting portion and the second connecting portion away from the second plate body are respectively fixed to the supporting portion; the magnetic circuit system includes a first main magnet unit and a second main magnet unit arranged side by side and fixed to a side of the supporting portion away from the first diaphragm, first side magnets fixed to the second plate body and arranged on opposite sides of the first main magnet unit along a direction parallel to the longitudinal axis of the magnetic circuit system, and second side magnets fixed to the second plate body and arranged on opposite sides of the second main magnet unit along the direction parallel to the longitudinal axis of the magnetic circuit system; by having opposite first connecting portions and opposite second connecting portions in both length and width directions of the second plate, the manufacturing process difficulty of smaller coils in products with larger length-to-width ratios is reduced, greatly reducing the risk of deformation of the irregular plate after mechanical testing, improving plate safety, and broadening the application range.

The foregoing is merely illustrative of embodiments of the present invention, and it should be noted that modifications may be made to those skilled in the art without departing from the spirit of the invention but are intended to be within the scope of the inventio.

What is claimed is:

1. A sound generator, comprising:
a frame including a first frame and a second frame fixed to the first frame;
a first vibration system fixed to a side of the first frame away from the second frame, the first vibration system comprising a first diaphragm fixed to the first frame and a first coil for driving the first diaphragm to vibrate;
a second vibration system fixed to a side of the second frame away from the first frame; the second vibration system comprising a second diaphragm fixed to the second frame, a second coil and a third coil jointly driving the second diaphragm to vibrate;
a first plate with an outer periphery fixed to the first frame;
a second plate including an annular second plate body fixed to the second frame, a first connecting portion formed by bending and extending from opposite two sides of the second plate body in a direction away from the second diaphragm, a second connecting portion formed by bending and extending from another opposite two sides of the second plate body in the direction away from the second diaphragm, and a supporting portion parallel to the second plate body and located on a side of the second plate body close to the first diaphragm; ends of the first connecting portion and the second connecting portion away from the second plate body being respectively fixed to the supporting portion; and
a magnetic circuit system, including a first main magnet unit, a second main magnet unit arranged by the first main magnet unit and fixed to a side of the supporting portion away from the first diaphragm, first side magnets fixed to the second plate body and arranged on opposite sides of the first main magnet unit along a direction parallel to a longitudinal axis of the magnetic circuit system, and second side magnets fixed to the second plate body and arranged on opposite sides of the second main magnet unit along the direction parallel to a longitudinal axis of the magnetic circuit system; wherein
the first side magnets and the second side magnets are respectively spaced apart from the first main magnet unit and the second main magnet unit to form magnetic gaps, the second coil and the third coil are respectively spaced apart within the first coil, and the first coil, the second coil and the third coil are respectively inserted into the magnetic gaps; the first side magnets and the second side magnets are respectively fixed to the first plate.

2. The sound generator as described in claim 1, wherein the second plate body, the first connecting portion, the second connecting portion and the supporting portion are integrally formed.

3. The sound generator as described in claim 1, wherein the first connecting portion, the second connecting portion and the supporting portion are integrally formed, and are fixedly connected to the second plate body through the first connecting portion and the second connecting portion.

4. The sound generator as described in claim 3, wherein a first recess and a second recess are respectively formed by recessing on a side of the second plate body close to the second diaphragm, the first recess is located at the opposite two sides of the second plate body, and the second recess is located at the other opposite two sides of the second plate body;
the first connecting portion comprises a first connecting portion body fixed to the supporting portion and a first step formed by recessing from the first connecting portion body in a direction away from the first diaphragm; the first step is disposed in the first recess;
the second connecting portion comprises a second connecting portion body fixed to the supporting portion and a second step formed by recessing from the second connecting portion body in the direction away from the first diaphragm; the second step is disposed in the second recess.

5. The sound generator as described in claim 1, wherein the first diaphragm comprises an annular first suspension, a first fixing portion extending outward from an outer periphery of the first suspension, a first vibration unit extending inward from an inner periphery of the first suspension, and a first dome fixed to a side of the first vibration unit close to the second vibration system; the first fixing portion is fixed to the side of the first frame away from the second vibration system, and the first coil is fixed to a side of the first dome close to the second vibration system.

6. The sound generator as described in claim 1, further comprising a first circuit board, one end of the first circuit board is fixed to a side of the first frame close to the second frame, and another end of the first circuit board is fixed to a side of the first coil away from the second vibration system to achieve electrical connection.

7. The sound generator as described in claim 1, wherein the second diaphragm comprises an annular second suspension, a second fixing portion extending outward from an outer periphery of the second suspension, a second vibration unit extending inward from an inner periphery of the second suspension, and a second dome fixed to a side of the second vibration unit away from the first vibration system; the second fixing portion is fixed to the side of the second frame away from the first vibration system, and the second coil and the third coil are respectively fixed to a side of the second fixing portion away from the second dome.

8. The sound generator as described in claim 7, further comprising a second circuit board, the second circuit board is stacked and fixed to the side of the second frame away from the first vibration system; the second diaphragm is stacked and fixed to a side of the second circuit board away from the first frame, the second coil and the third coil are respectively fixed to a side of the second circuit board close to the first vibration system, and the second circuit board is respectively electrically connected to the second coil and the third coil.

9. The sound generator as described in claim 1, wherein the first main magnet unit comprises a first main magnet fixed to the supporting portion and a first pole plate stacked and fixed to a side of the first main magnet away from the first vibration system; the second main magnet unit comprises a second main magnet fixed to the supporting portion and a second pole plate stacked and fixed to a side of the second main magnet away from the second vibration system; the first main magnet and the second main magnet respectively form the magnetic gaps with the first side magnets and the second side magnets.
